(19) United States
(12) Patent Application Publication
(10) Pub. No.: US 2021/0254400 A1
(43) Pub. Date: Aug. 19, 2021

(54) SPRING BOX FOR WINDOW COVERING

(71) Applicant: Nien Made Enterprise Co., Ltd., Taichung City (TW)

(72) Inventors: Wei-Ching Lin, Taichung (TW); Lin Chen, Taichung City (TW)

(21) Appl. No.: 17/109,083

(22) Filed: Dec. 1, 2020

(30) Foreign Application Priority Data
Feb. 14, 2020 (CN) 202020169742.8

(51) Int. Cl. E06B 9/322

(52) U.S. Cl. CPC E06B 9/322; E06B 2009/3225; E06B 2009/3222

(57) ABSTRACT

A spring box, which can be used in a window covering, includes a prestressing device, a cord reel, and a cord-guiding shaft provided on a horizontal plane of a base. The prestressing device provides a force to the cord reel to rotate the cord reel and wind up a lift cord, wherein the lift cord contacts and goes around the cord-guiding shaft before being connected to the covering material of the window covering. By providing the cord-guiding shaft at a predetermined tilt orientation and tilt angle, the lift cord can be properly guided and the movement thereof can be restrained. In this way, during the process of winding up, the lift cord can be prevented from having its cord loops overlapping or tangling with each other.

### BACKGROUND OF THE DISCLOSURE

### 1. Field of the Disclosure

The present disclosure relates generally to a window covering, and more particularly to a spring box for a window covering.

### 2. Description of the Prior Art

It is known that a cordless window covering uses a spring box provided in a rail thereof for collecting and releasing the lift cord when the rail is moving. The aforementioned spring box generally includes a cord-collecting assembly and an elastic assembly. The cord-collecting assembly includes at least one cord reel adapted to release or collect the lift cord. The released lift cord is wrapped around a plurality of upright disposed cord-guiding shafts, whereby to change its direction before running out from the spring box. The elastic assembly can be operated along with the cord-collecting assembly. The elastic assembly includes a spiral spring which provides a pulling force to offset the weight of the covering material of the window covering. Therefore, the rail can stay at a desired position without providing any external force, so as to achieve the purpose of controlling the size of the area blocked by the window covering.

During the process of moving the rail to retract the window covering, the lift cord is continuously wrapped around and stacked on the shaft of the cord reel, so as to reduce the length of the released lift cord. Since the lift cord is confined by the flanges located at both ends of the shaft, it would not escape from the shaft when the lift cord is wrapped and stacked along the axial direction of the shaft either from bottom up or from top down. However, when the lift cord continuously and repeatedly stacks on and wraps around the shaft between the two flanges, the sequential arrangement of the lift cord may be impeded by the flanges, so that cord loops may overlap or tangle with each other because of the inertia of moving from bottom up or from top down. As a result, the lift cord may be stuck while being released or wrapped up, and the cord reel may not be able to rotate smoothly or even be completely stuck. Alternatively, if multiple cord reels are provided, the length of the lift cord released from each cord reel may be different, causing the rail to tilt when in a free state.

### SUMMARY OF THE DISCLOSURE

In view of the above, the objective of the present disclosure is to provide a spring box for a window covering. The spring box could make the wrapped lift cord tidily and sequentially arranged, and therefore could avoid the cord loops from overlapping or tangling with each other.

To achieve the above objective, the present disclosure provides a spring box for a window covering. The window covering has a covering material and a flit cord having an end connected to the covering material. The spring box includes a base, a prestressing device disposed on a horizontal plane of the base, a cord reel which is also disposed on the horizontal plane of the base, and a cord-guiding shaft. The cord reel is adapted to be rotated by a force provided by the prestressing device to wind up the lift cord of the window covering. The cord-guiding shaft is not perpendicular to, but tilted with respect to the horizontal plane of the base. When the spring box is installed in the window covering, the cord-guiding shaft is disposed between the cord reel and the covering material, and is adapted to be gone around by the lift cord extending from the cord reel before the lift cord is being connected to the covering material.

In one embodiment, when the spring box is installed in the window covering, the cord-guiding shaft is adapted to serve as a defining boundary which divides the lift cord into a front-segment, which is connected to the cord reel, and a rear-segment, which is connected to the covering material. When in such arrangement, the horizontal plane of the base is defined to have a first extension line extending along a projection of a running direction of the front-segment and a second extension line extending along a projection of a running direction of the rear-segment. The cord-guiding shaft is defined to have an axis passing through a top end and a bottom end thereof, and a projection of the axis on the horizontal plane of the base is defined as a projection axis. The first extension line and the second extension line intersect at the projection axis, and the projection axis perpendicularly intersects an angle bisector of an included angle formed between the first extension line and the second extension line.

In one embodiment, when the spring box is installed in the window covering, the cord-guiding shaft is adapted to serve as a defining boundary which divides the lift cord into a front-segment, which is connected to the cord reel, and a rear-segment, which is connected to the covering material. When in such arrangement, the horizontal plane of the base is defined to have a first extension line extending along a projection of a running direction of the front-segment and a second extension line extending along a projection of a running direction of the rear-segment. An included angle is formed between the first extension line and the second extension line. When in such arrangement, the first extension line and the second extension line are respectively in directions of two component forces applied by the lift cord to the cord-guiding shaft, and an angle bisector evenly splitting the included angle is in a direction of a resultant force applied by the lift cord to the cord-guiding shaft. The cord-guiding shaft is defined to have an axis passing through a top end and a bottom end thereof, and a projection of the axis on the horizontal plane of the base is defined as a projection axis. The first extension line and the second extension line intersect at the projection axis to form the included angle, and the projection axis is perpendicular to the direction of the resultant force.

In one embodiment, when the spring box is installed in the window covering, a projection of a position where the lift cord extending from the cord reel on the horizontal plane of the base is defined as a first constraint point, and a projection of another position where the lift cord turns for a first time after going around the cord-guiding shaft on the horizontal plane of the base is defined as a second constraint point. One end of the first extension line is the first constraint point and the other end of the first extension line is at the projection axis, one end of the second extension line is at the projection axis and the other end of the second extension line is the second constraint point. The first extension line, the second extension line, and a bottom edge formed by connecting the first constraint point and the second constraint point forma triangle, which has the included angle located at a vertex thereof.

In one embodiment, a position where the first extension line and the second extension line intersect to form the included angle is where a sum of a length of the first extension line and a length of the second extension line is smallest.

In one embodiment, the cord-guiding shaft is a cylinder.

By establishing the cord-guiding shaft with a desired tilt angle, the lift cord could be tidily and sequentially wrapped with the guide of the offset cord-guiding shaft.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

The present disclosure will be best understood by referring to the following detailed description of some illustrative embodiments in conjunction with the accompanying drawings, in which

FIG. 1 is a perspective view illustrating a cordless window covering with a spring box according to one embodiment of the present disclosure;

FIG. 2 is a partial exploded view illustrating the spring box according to one embodiment of the present disclosure;

FIG. 3 is a top view illustrating the structure shown in FIG. 2 without the upper lid;

FIG. 4 is a front side view of FIG. 3;

FIG. 5 is a schematic diagram illustrating the structure shown in FIG. 3 with some components being simplified;

FIG. 6(A) is a simplified projection diagram of the front-segment, the rear-segment, and the cord-guiding shaft shown in FIG. 5;

FIG. 6 (B) is similar to FIG. 6 (A), illustrating the lift cord when it turns at the top portion of the cord-guiding shaft;

FIG. 6 (C) is similar to FIG. 6 (A), illustrating the lift cord when it turns at the bottom portion of the cord-guiding shaft;

FIG. 7 is a top view illustrating some components of the spring box according to another embodiment of the present disclosure; and

FIG. 8 is a schematic diagram illustrating the structure shown in FIG. 7 with some components being simplified.

### DETAILED DESCRIPTION

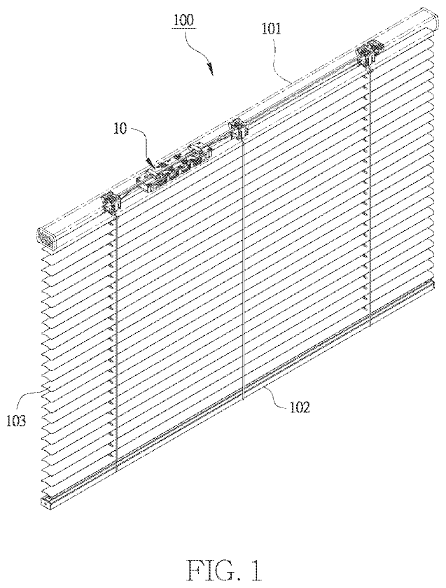

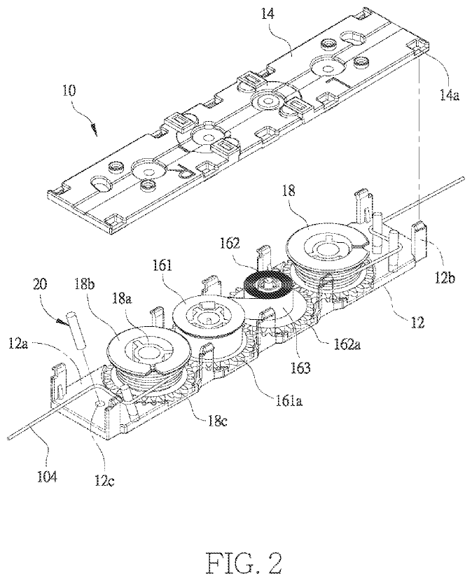

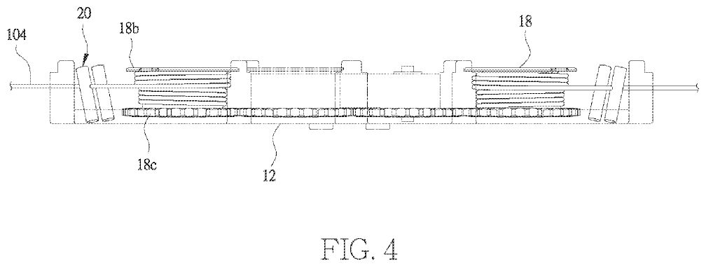

In order to explain the present disclosure more clearly, the preferred embodiments are described in detail with the accompanying drawings as follows. Please refer to FIG. 1, which is a schematic diagram of an expanded-state cordless window covering 100 with a spring box 10 according to one embodiment of the present disclosure. The cordless window covering 100 includes two rails, a head rail 101 and a bottom rail 102, and a covering material 103 disposed between the head rail 101 and the bottom rail 102 and composed of a plurality of slats. The spring box 10 of the present embodiment is disposed in the head rail 101 and is adapted to wind up or release out the lift cord 104 connected to the bottom rail 102 when the bottom rail 102 is moved. Please refer to FIG. 2 to FIG. 4, the spring box 10 includes a base 12, an upper lid 14, a prestressing device 16, a cord reel 18, and a cord-guiding shaft 20. Each component will be described in following paragraphs.

The base 12 is fixed at a predetermined position in the head rail 101. The base 12 has a horizontal plane 12a and a plurality of snap-fitting ribs 12b extending upward from the horizontal plane 12a. The upper lid 14 has a plurality of snap-fitting holes 14a corresponding to the snap-fitting ribs 12b, so that the upper lid 14 can be engaged with (e.g. snap-fitted to) the base 12 in a snap-fitting manner. It should be realized that the aforementioned snap-fitting ribs 12b and snap-fitting holes 14a are used to engage the upper lid 14 with the base 12; however, the structures described herein are not limitations. Any structures which are capable of keeping the upper lid and the base from moving relative to each other would be feasible.

The prestressing device 16, the cord reel 18, and the cord-guiding shaft 20 are disposed between the base 12 and the upper lid 14. The prestressing device 16 includes a spring-winding wheel 161, a spring-storage wheel 162, and a spiral spring 163. The spring-winding wheel 161 and the spring- storage wheel 162 are disposed and configured to rotate in situ on the horizontal plane 12a of the base 12. A toothed disk 161a at a bottom of the spring-winding wheel 161 moves synchronously with the spring-winding wheel 161. A toothed disk 162a at a bottom of the spring-storage wheel 162 may be provided independent of the spring-storage wheel 162 to rotate on its own as an idler toothed disk. The toothed disk 161a of the spring-winding wheel 161 is meshed with the toothed disk 162a of the spring-storage wheel 162, so that the rotation of the spring-winding wheel 161 may synchronously rotate the toothed disk 161a and the toothed disk 162a together. The spiral spring 163 is wound around the spring-winding wheel 161 and the spring-storage wheel 162 in an S shape, and two ends of the spiral spring 163 are respectively fixedly connected to the spring-winding wheel 161 and the spring-storage wheel 162. When the spring-winding wheel 161 and the spring-storage wheel 162 change their rotation directions, the number of rounds of the spiral spring 163 wound on the spring-winding wheel 161 and the spring-storage wheel 162 will change, and a pulling force generated by the spiral spring 163 will indirectly act on the cord reel 18. When the bottom rail 102 is at a position closest to the head rail 101, that is, when the slats of the covering material 103 are tightly stacked upon each other, most part of the spiral springs 163 is wound around the spring-storage wheel 162. The spring-storage wheel 162 may have a wheel-shaped or shaft-shaped configuration as disclosed in the present embodiment, or it could also be a cylindrical hollow space which is adapted to accommodate the spiral spring 163 in other embodiments. In addition, an end of the spiral spring 163 may be fixedly connected to the spring-storage wheel 162, or it may just be wound around the spring-storage wheel 162. These configurations are common design variations in the technical field of window coverings, and are not subject matters of the present disclosure. Therefore, those which should be considered technically equivalent will not be further described herein.

In the present embodiment, there are two cord reels 18 respectively disposed and configured to rotate in situ on the outer sides of the spring-winding wheel 161 and the spring-storage wheel 162. Each cord reel 18 is composed of a shaft 18a, and a wheel disk 18b and a toothed disk 18c which are respectively connected to a top end and a bottom end of the shaft 18a. The two cord reels 18 are respectively meshed with the toothed disk 161a of the spring-winding wheel 161 and the toothed disk 162a of the spring-storage wheel 162 through the toothed disk 18c at bottom, whereby to be driven by the spring-winding wheel 161 to rotate in a correlated manner with each other. There is one lift cord 104 fixedly connected to and wound around the shaft 18a of each of the cord reels 18. The lift cords 104 may be released out or retracted by the shaft 18a as the rotating direction of the cord reels 18 changes. Moreover, each of the lift cords 104 would not escape from the corresponding wheel disk 18b and toothed disk 18c since it is confined therebetween. When the bottom rail 102 moves away from the head rail 101, the lift cords 104 are released; when the bottom rail 102 moves towards the head rail 101, the lift cords 104 are reeled in.

In the present embodiment, the cord-guiding shaft 20 is a cylinder, and there are two cord-guiding shafts 20 arranged as a group provided on the outer sides of each of the cord reels 18. Every time the lift cords 104 go around and contact any one of the cord-guiding shafts 20, the running direction thereof is changed. It should be noted that each of the cord-guiding shafts 20 of the present disclosure is arranged in an inclined manner, so that it would be able to guide and restrain the lift cord 104 going around. Please refer to FIG. 2, in the present embodiment, the base 12 is prefabricated with oblique holes 12c, so that the cord-guiding shafts 20 could be quickly inserted and is obliquely arranged after the insertion. On each side of the spring box 10, when the lift cord 104 is wound up and wrapped about the axial direction of the shaft 18a of the cord reel 18 from bottom up or from top down, the oblique design of the cord-guiding shafts 20 may help to keep the lift cord 104 as close as possible to the middle portion of the cord-guiding shafts 20. As a result, the moving inertia of the lift cord 104 when it is wound about the axial direction of the shaft 18a may be inhibited. Accordingly, the problem that the cord loops of the lift cord 104 may overlap or tangle with each other at the positions near the wheel disk 18b or the toothed disk 18c could be avoided. Therefore, the lift cord 104 could be ensured to have a tidy and sequential winding-up.

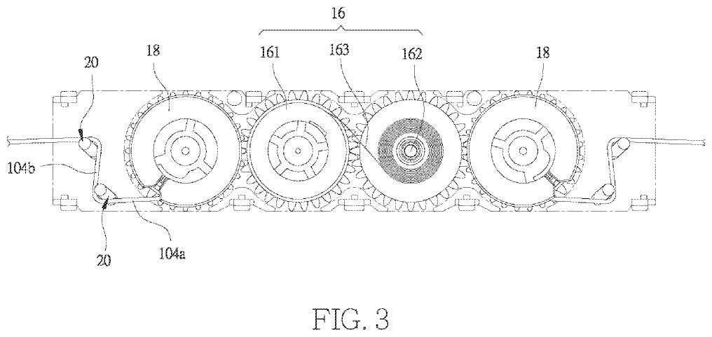

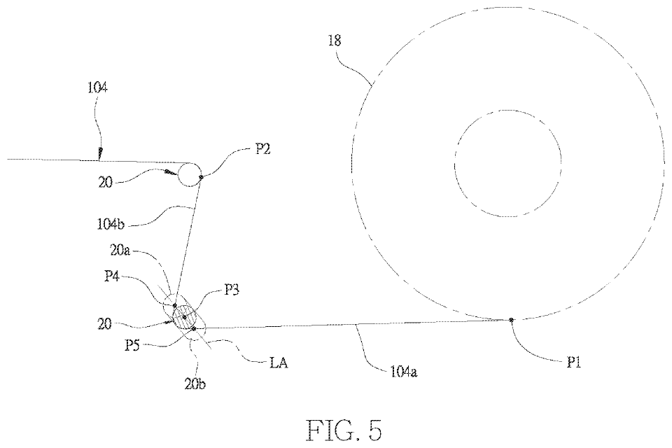

The principle for obliquely providing the cord-guiding shaft to achieve the above purposes is described below. The oblique direction of the cord-guiding shaft 20 should be defined first. Herein we take the two cord-guiding shafts on the left side of the structure shown in FIG. 3 as examples. Since the structures and arrangements of the two cord-guiding shafts are the same, only one cord-guiding shaft, accompanied with the lift cord going around, is used for explanation in the following description. Please refer to FIG. 5, which is a schematic diagram illustrating the structure shown in FIG. 3 with some components simplified. The lift cord 104 can be, by definition, divided into a front-segment 104a and a rear-segment 104b with the cord-guiding shaft 20 used as a boundary. The front-segment 104a connects the cord reel 18 and the cord-guiding shaft 20. The projection of the position where the lift cord 104 comes out from the cord reel 18 on the horizontal plane 12a of the base 12 is defined as a first constraint point P1. The rear-segment 104b extends from the cord-guiding shaft 20 to the other one of the cord-guiding shafts 20 which is not used for explanation. The projection of the position where the lift cord 104 turns at said other one of the cord-guiding shafts 20 on the horizontal plane 12a of the base 12 is defined as a second constraint point P2. In addition, the cord-guiding shaft 20 is defined to have an axis passing through central portions of a top end 20a and a bottom end 20b thereof. The projection of the axis on the horizontal plane 12a of the base 12 is defined as a projection axis LA. The projection axis LA is defined to have an axial projection point P3, an axial projection point P4, and an axial projection point P5, which respectively are projections of points at a center, at the top end 20a, and at the bottom end 20b of the cord-guiding shaft 20.

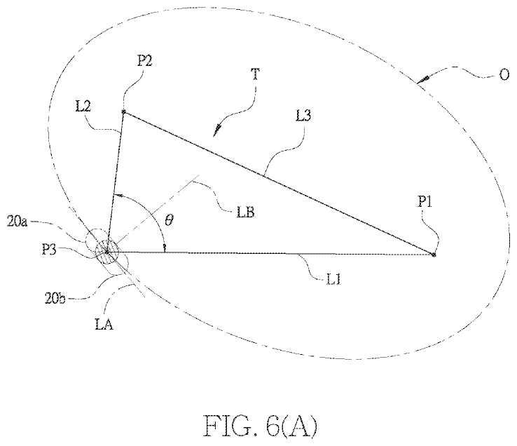

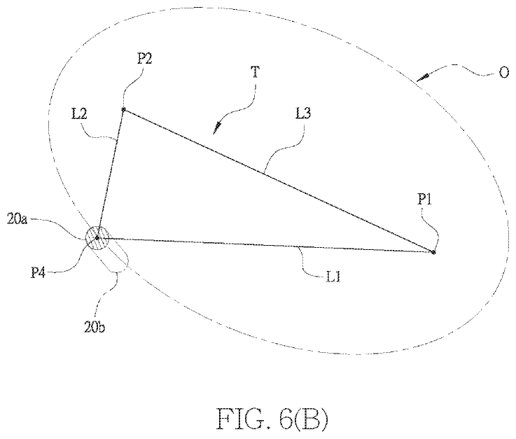

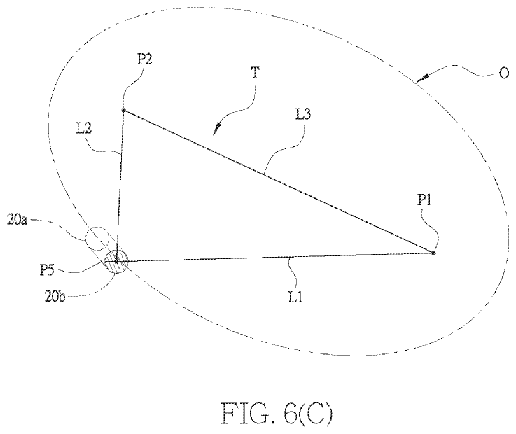

As shown in FIG. 6 (A), which is a simplified projection schematic diagram of the front-segment 104a, the rear-segment 104b, and the cord-guiding shaft 20 shown in FIG. 5. A first extension line L1 is substantially defined by a projection of the running direction of the front-segment 104a between the cord-guiding shaft 20 and the first constraint point P1 on the horizontal surface 12a of the base 12. The first extension line L1 connects the first constraint point P1 and the axial projection point P3. A second extension line L2 is substantially defined by a projection of the running direction of the rear-segment 104b between the two cord-guiding shafts 20 on the horizontal surface 12a of the base 12. The second extension line L2 connects the second constraint point P2 and the axial projection point P3. In addition, a bottom edge L3 is defined by connecting the first constraint point P1 and the second constraint point P2, with two ends thereof corresponding to the first constraint point P1 and the second constraint point P2, respectively. Therefore, the bottom edge L3, the first extension line L1, and the second extension line L2 constitute a triangle T. The first extension line L1 and the second extension line L2 intersect at the axial projection point P3 and form an included angle θ. In the present embodiment, the included angle θ is an acute angle.

The projection axis LA is further defined herein. The projection axis LA intersects the first extension line L1 and the second extension line L2. An angle bisector LB is further defined to divide the included angle θ evenly. The projection axis LA is approximately perpendicular to the angle bisector LB. It can be realized that the directions of the first extension line L1 and the second extension line L2 respectively correspond to the directions of the component forces applied to the cord-guiding shaft 20. As a result, when in a circumstance that the frictional force generated between the cord-guiding shaft 20 and the lift cord 104 can be ignored (say, if the surface of the cord-guiding shaft 20 is smooth), the direction of the angle bisector LB would be the direction of the resultant force, and the direction of the projection axis LA of the cord-guiding shaft 20 is perpendicular to the direction of the resultant force. Therefore, if the frictional force generated between the cord-guiding shaft 20 and the lift cord 104 is noticeable, the component forces applied by the lift cord 104 to the cord-guiding shaft 20 may not completely correspond to the first extension line L1 and the second extension line L2; instead, there would be a slight deviation. In other words, when there is a frictional force generated between the cord-guiding shaft 20 and the lift cord 104, the actual angle bisector of the angle formed between the first extension line L1 and the second extension line L2 would not completely overlap, but slightly deviates from the direction of the resultant force. Therefore, in order to make the angle bisector LB in line with the direction of the resultant force again, the cord-guiding shaft 20 could be arranged in a manner that the projection axis LA thereof not exactly perpendicular to, but a slightly inclined from the angle bisector LB. That is, the projection axis LA of the cord-guiding shaft 20 is roughly perpendicular to the angle bisector LB.

The characteristics of the axial projection point P3 at the intersection point of the first extension line L1 and the second extension line L2 are further described below. The axial projection point P3 is a vertex of the triangle T. Under the premise that the first constraint point P1 and the second constraint point P2 stay at where they are (i.e., the length of the bottom edge L3 forming the triangle T is fixed), a sum of the distance between the first constraint point P1 and the axial projection point P3 (i.e., the length of the first extension line L1) and the distance between the second constraint point P2 and the axial projection point P3 (i.e., the length of the second extension line L2) is defined as T1. Meanwhile, an ellipse O could be drawn based on related mathematics definitions by taking the first constraint point P1 and the second constraint point P2 as the two focal points and taking the axial projection point P3 (the vertex of the triangle T) as a point on the circumference of the ellipse. Next, please refer to FIG. 6(B) and FIG. 6(C), wherein FIG. 6(B) illustrates the first extension line L1 and the second extension line L2 formed when the lift cord 104 goes around at a position near the top end 20a of the cord-guiding shaft 20. FIG. 6 (B) also illustrates the axial projection point P4 where the first and second extension lines L1, L2 intersect. Under the premise that the length of the bottom edge L3 is fixed, a sum of the distance between the first constraint point P1 and the axial projection point P4 and the distance between the second constraint point P2 and the axial projection point P4 is defined as T2. FIG. 6 (C) illustrates the first extension line L1 and the second extension line L2 formed when the lift cord 104 goes around at a position near the bottom end 20b of the cord-guiding shaft 20. FIG. 6(C) also illustrates the axial projection point P5 where the first and second extension lines L1, L2 intersect. Under the premise that the length of the bottom edge L3 is fixed, a sum of the distance between the first constraint point P1 and the axial projection point P5 and the distance between the second constraint point P2 and the axial projection point P5 is defined as T3.

Since the axial projection point P3 is located on the circumference of the ellipse O, and the projection axis LA is a straight line passing through the axial projection point P3 and perpendicular to the angle bisector LB (i.e., the direction of the resultant force applied by the lift cord 104 to the cord-guiding shaft 20), the axial projection point P4 and the axial projection point P5 would located out of the circumference of the ellipse O although they are located on the projection axis LA as well as the axial projection point P3. Accordingly, T2, which corresponds to the axial projection point P4, would be greater than T1, which corresponds to the axial projection point P3, and T3, which corresponds to the axial projection point P5, would be also greater than T1, which corresponds to the axial projection point P3. In other words, in the case where the cord-guiding shaft 20 is oblique as aforementioned, the axial projection point P3 is located at the position where makes a sum of a length (T) of the first extension line L1 and a length of the second extension line L2 smallest. Also, under the premise that the positions of the first constraint point P1 and the second constraint point P2 are unchanged, when the lift cord 104 goes around the cord-guiding shaft 20, it tends to get close to the axial projection point P3. That is, when the lift cord 104 goes around the cord-guiding shaft 20, it tends to pass through the middle portion of the cord-guiding shaft 20. It should be noted that in order to facilitate installation and avoid overturning, the inclined angle between the axial direction of the cord-guiding shaft 20 and the normal direction of the horizontal plane 12a of the base 12 is preferably no greater than 45 degrees, but it is not limited thereto. Therefore, when the lift cord 104 is reeled in and wound along the axial direction of the shaft 18a of the corresponding cord reel 18 from bottom up or from top down, the lift cord 104 would automatically move toward the middle portion of the cord-guiding shaft 20, suppressing the moving inertia of the lift cord 104 when it is wound along the axial direction, thereby to prevent the problem that the lift cord 104 may overlap or tangle with each other at positions near the wheel disk 18b or the toothed disk 18c.

Based on the aforementioned definition, the method for obliquely establishing the cord-guiding shaft 20 is performed by positioning the axial projection point P4 of the top end 20a and the axial projection point P5 of the bottom end 20b of the cord-guiding shaft 20 on the projection axis LA, and positioning the axial projection point P3 of the middle portion of the cord-guiding shaft 20 at the intersection of the projection axis LA and the angle bisector LB (i.e., the direction of the resultant force). Similarly, the other cord-guiding shaft of the two cord-guiding shafts disposed on the same side is also arranged in the same oblique direction according to the same rules. For the other cord-guiding shaft, the first constraint point is located on the tangent line formed between the two adjacent cord-guiding shafts by the lift cord. Specifically, the first constraint point is the intersection point of said tangent line and the nearby cord-guiding shaft. The second constraint point is the point where the lift cord turns after running out from the spring box and about to extend out of the head rail to turn down toward the bottom rail.

In the above configuration, the included angle θ formed between the first extension line L1 and the second extension line L2 which are projected on the horizontal plane 12a of the base 12 is an acute angle, but it is not limited thereto. According to the above rules, it should be realized that when the position of the cord-guiding shaft is changed to produce different first and second constraint points, the oblique angle of the cord-guiding shaft would be different. The details are described below.

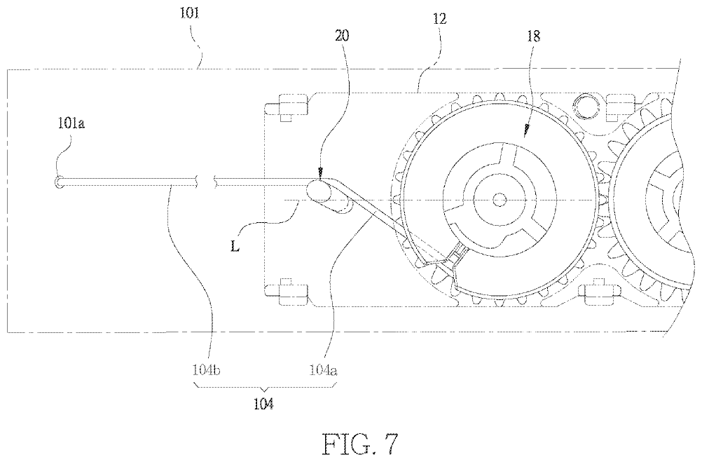

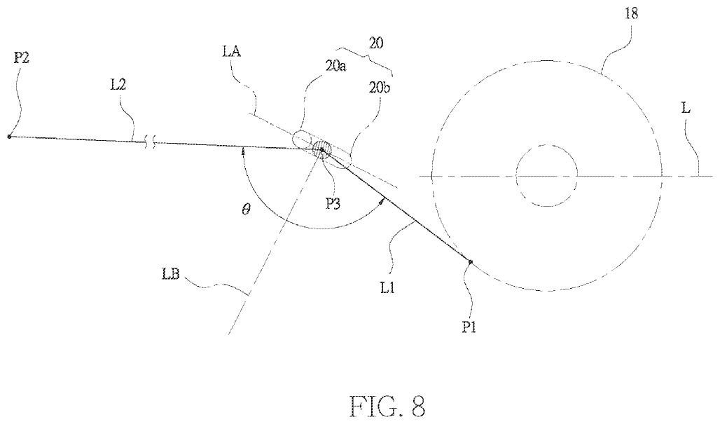

Please refer to another embodiment shown in FIG. 7 and FIG. 8: the cord-guiding shaft 20 is disposed on the outer side of the cord reel 18, and the bottom end of the cord-guiding shaft 20 is located on the extension line L of the rotation axis of the cord reel 18. Based on the above rules, the lift cord 104 of the present embodiment can be, by definition, divided into a front-segment 104a and a rear-segment 104b using the cord-guiding shaft 20 as a boundary. The front-segment 104a directly connects the cord-guiding shaft 20 and the cord reel 18. The rear-segment 104b extends from the cord-guiding shaft 20 to a predetermined position 101a of the head rail 101, and then turns downward to extend out of the head rail, with an end thereof connected to the bottom rail. The aforementioned predetermined position may be a perforation or a direction-changing post provided on the head rail. In the present embodiment, a perforation is taken as an example. Herein we define that a projection of the position where the lift cord 104 extending from the cord reel 18 on the horizontal plane 12a of the base 12 is defined as a first constraint point P1, and a projection of the predetermined position 101a on the horizontal plane 12a of the base 12 is defined as a second constraint point P2. A first extension line L1 and a second extension line L2 are also defined on the horizontal plane 12a of the base 12, wherein the first extension line L1 is substantially drawn along the running direction of the front-segment 104a, while the second extension line L2 is substantially drawn along the running direction of the portion of the rear-segment 104b that goes from the cord-guiding shaft 20 to the predetermined position 101a. As described in the above embodiments, when the total length of the first extension line L1 and the second extension line L2 is the smallest, the intersection point of the first extension line L1 and the second extension line L2 is the axial projection point P3 which corresponds to the middle portion of the cord-guiding shaft 20. Moreover, in the present embodiment, the included angle θ formed between the first extension line L1 and the second extension line L2 is an obtuse angle. Similarly, the angle bisector LB equally divides the obtuse included angle θ. The projection axis LA of the cord-guiding shaft 20 not only intersects the first extension line L1 and the second extension line L2 which are projected on the horizontal plane 12a of the base 12, but also perpendicularly intersects the angle bisector LB. When the projection axis LA of the cord-guiding shaft 20 perpendicularly intersects the angle bisector LB, the axis projection points of the top end 20a and the bottom end 20b of the cord-guiding shaft 20 are respectively positioned on the projection axis LA. It can be seen that, in order to ensure the lift cord to be tidily wound, the oblique angle of the cord-guiding shaft would be different when single lift cord changes its running direction with only one cord-guiding shaft or with two cord-guiding shafts.

It has to be further clarified that the spring box of the present disclosure is not limited to be provided on the head rail or the fixed rail of window coverings. Depending on functional requirements, in structures of other specific implementations, the spring box may be provided in other movable rails such as middle rails or bottom rails, or even rails having the same constructions as the covering material, such as the situation in some window coverings, of which the bottom rail itself is the bottommost slat of the covering material. On the other hand, although the covering material described in the above embodiments as an example is composed of a plurality of slats, the covering material could be a cellular shade or a pleated shade in other embodiments. Also, in other embodiments, the spiral spring could also be a variable force spring or a constant force spring as required. In addition, the objective of the present disclosure is to tidily arrange the lift cord, so the first priority is to provide an oblique cord-guiding shaft which is closest to the cord reel while the configuration of other cord-guiding shafts (for example, whether oblique or not) are not limited in the present disclosure. Moreover, although the cord-guiding shaft belongs to the spring box as a part thereof, it may also be provided outside the spring box.

It must be pointed out that the embodiments described above are only some preferred embodiments of the present disclosure. All equivalent structures which employ the concepts disclosed in this specification and the appended claims should fall within the scope of the present disclosure.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A spring box for a window covering, wherein the window covering has a covering material and a lift cord having an end connected to the covering material; the spring box comprising:
a base;
a prestressing device disposed on a horizontal plane of the base;
at least one cord reel, which is also disposed on the horizontal plane of the base, and is adapted to be rotated by a force provided by the prestressing device to wind up the lift cord of the window covering; and
a cord-guiding shaft, which is not perpendicular to, but tilted with respect to the horizontal plane of the base, wherein, when the spring box is installed in the window covering, the cord-guiding shaft is disposed between the cord reel and the covering material of the window covering, and is adapted to be gone around by the lift cord extending from the cord reel before the lift cord is being connected to the covering material.

2. The spring box as claimed in claim 1, wherein, when the spring box is installed in the window covering, the cord-guiding shaft is adapted to serve as a defining boundary which divides the lift cord into a front-segment, which is connected to the cord reel, and a rear-segment, which is connected to the covering material; when in such arrangement, the horizontal plane of the base is defined to have a first extension line extending along a projection of a running direction of the front-segment and a second extension line extending along a projection of a running direction of the rear-segment; wherein the cord-guiding shaft is defined to have an axis passing through a top end and a bottom end thereof, and a projection of the axis on the horizontal plane of the base is defined as a projection axis; wherein the first extension line and the second extension line intersect at the projection axis, and the projection axis perpendicularly intersects an angle bisector of an included angle formed between the first extension line and the second extension line.

3. The spring box as claimed in claim 2, wherein, a projection of a position where the lift cord extending from the cord reel on the horizontal plane of the base is defined as a first constraint point, and a projection of another position where the lift cord turns for a first time after passing by the cord-guiding shaft on the horizontal plane of the base is defined as a second constraint point; wherein one end of the first extension line is the first constraint point and the other end of the first extension line is at the projection axis, one end of the second extension line is at the projection axis and the other end of the second extension line is the second constraint point; wherein the first extension line, the second extension line, and a bottom edge formed by connecting the first constraint point and the second constraint point form a triangle, which has the included angle located at a vertex thereof.

4. The spring box as claimed in claim 3, wherein a position where the first extension line and the second extension line intersect to form the included angle is where a sum of a length of the first extension line and a length of the second extension line is smallest.

5. The spring box as claimed in claim 3, wherein the cord-guiding shaft is a cylinder.

6. The spring box as claimed in claim 1, wherein, when the spring box is installed in the window covering, the cord-guiding shaft is adapted to serve as a defining boundary which divides the lift cord into a front-segment, which is connected to the cord reel, and a rear-segment, which is connected to the covering material; when in such arrangement, the horizontal plane of the base is defined to have a first extension extending along a projection of a running direction of the front-segment and a second extension line extending along a projection of a running direction of the rear-segment; wherein an included angle is formed between the first extension line and the second extension line; wherein, when in such arrangement, the first extension line and the second extension line are respectively in directions of two component forces applied by the lift cord to the cord-guiding shaft, and an angle bisector evenly splitting the included angle is in a direction of a resultant force applied by the lift cord to the cord-guiding shaft; wherein the cord-guiding shaft is defined to have an axis passing through a top end and a bottom end thereof, and a projection of the axis on the horizontal plane of the base is defined as a projection axis; wherein the first extension line and the second extension line intersect at the projection axis to form the included angle, and the projection axis is perpendicular to the direction of the resultant force.

7. The spring box as claimed in claim 6, wherein, a projection of a position where the lift cord extending from the cord reel on the horizontal plane of the base is defined as a first constraint point, and a projection of another position where the lift cord turns for a first time after going around the cord-guiding shaft on the horizontal plane of the base is defined as a second constraint point; wherein one end of the first extension line is the first constraint point and the other end of the first extension line is at the projection axis, one end of the second extension line is at the projection axis and the other end of the second extension line is the second constraint point; wherein the first extension line, the second extension line, and a bottom edge formed by connecting the first constraint point and the second constraint point form a triangle, which has the included angle located at a vertex thereof.

8. The spring box as claimed in claim 7, wherein a position where the first extension line and the second extension line intersect to form the included angle is where a sum of a length of the first extension line and a length of the second extension line is smallest.

9. The spring box as claimed in claim 7, wherein the cord-guiding shaft is a cylinder.
